(19) United States
(12) Patent Application Publication
(10) Pub. No.: US 2020/0108408 A1
(43) Pub. Date: Apr. 9, 2020

(54) DIGITALLY CONTROLLED CHEMICAL DISPERSAL DEVICE

(71) Applicant: David W. DUFF, Medford, MA (US)

(72) Inventor: David W. DUFF, Medford, MA (US)

(21) Appl. No.: 16/590,471

(22) Filed: Oct. 2, 2019

Related U.S. Application Data
(60) Provisional application No. 62/740,531, filed on Oct. 3, 2018.
(60) Provisional application No. 62/792,414, filed on Jan. 15, 2019.
(60) Provisional application No. 62/855,269, filed on May 31, 2019.

(51) Int. Cl. B05B 12/02; B05B 9/04; A01M 7/00

(52) U.S. Cl. CPC B05B 12/02; A01M 7/0089; A01M 7/0046; B05B 9/0403

(57) ABSTRACT

A digitally controlled, wearable or stationary chemical dispersal device using a pump and activity-based or environmental-based feedback monitoring is described. The system contains a liquid chemical reservoir which can be replaced or refilled for multi-use operation. Electronic controls are used to drive the pump's liquid or air flow rate periodically with user control features and/or monitored, embedded digital sensors. Feedback from the sensors monitoring either the activity of a wearer of the device or the local environment can be used to adjust the pump's flow rate automatically. In addition, user selectable operation mode via Bluetooth is also described.

### CROSS-REFERENCE TO RELATED APPLICATIONS

This application claims the benefit of U.S. Provisional Application No. 62/740,531, filed Oct. 3, 2018, entitled “DIGITALLY CONTROLLED CHEMICAL DISPERSAL DEVICE,” and U.S. Provisional Application No. 62/792,414, filed on Jan. 15, 2019, entitled “DIGITALLY CONTROLLED CHEMICAL DISPERSAL DEVICE,” and U.S. Provisional Application No. 62/855,269, filed May 31, 2019, entitled “DIGITALLY CONTROLLED ALTERNATING PRESSURE GARMENT,” the entire contents of which is hereby incorporated herein by reference.

### BACKGROUND

The Arthropoda phylum of the animal kingdom has exoskeletons, jointed appendages, a body formed of a number of segments. Arthropods are members of the phylum Arthropoda and include the insects, arachnids and crustaceans. Many insects and arachnids are known to spread harmful diseases to both humans and animals. Many of these species are considered to be pests as well as to carry harmful diseases. The transmission of disease by Arthropods is a health concern to humans and animals world-wide. For example, diseases such as Lyme disease, human anaplasmosis, babesiosis, rickettsial diseases including Rocky Mountain spotted fever and typhus, ehrlichiosis, Powassan virus and tularemia are some diseases known to be transmitted by ticks. Preventative measures typically include toxic pesticides and insecticides.

### SUMMARY

An example of a digitally controlled dispersal system according to the disclosure includes a housing, a pump disposed within the housing, the pump including an input and output, a chemical reservoir disposed within the housing and fluidly coupled to the pump, a chemical dispersal orifice fluidly coupled to the chemical reservoir and configured to deliver volatized chemicals to an area outside of the housing, an electronic driver module operably coupled to the pump, the electronic driver module including at least one processor configured to determine an application value associated with a utilization of the digitally controlled dispersal system, set pump timing parameters based at least in part on the application value, and activate the pump based on the pump timing parameters.

Implementations of such a digitally controlled dispersal system may include one or more of the following features. The chemical reservoir may be fluidly connected to the pump input and the chemical dispersal orifice may be fluidly connected to the pump output. The chemical reservoir may be connected to the pump output and the pump may be configured to pump air into the chemical reservoir to deliver a chemical in the chemical reservoir to the chemical dispersal orifice. The chemical reservoir may include an absorbent material. A removable trap module may be configured to be attached and detached proximate to the chemical dispersal orifice. A heater module may be disposed proximate to the removable trap module. A secondary chemical reservoir may be fluidly connected to the chemical reservoir. The electronic driver module may include an Internet of Things (IoT) chipset. The electronic driver module may include a motion sensor configured to detect a motion of the digitally controlled dispersal system. The at least one processor may be operably coupled to the motion sensor and may be further configured to determine an activity value associated with the utilization of the digitally controlled dispersal system, and set the pump timing parameters based at least in part on the activity value. The at least one processor may be further configured to determine an environment value associated with the utilization of the digitally controlled dispersal system, and set the pump timing parameters based at least in part on the environment value. A wireless transceiver may be operably coupled to the at least one processor, and the at least one processor may be further configured to obtain the pump timing parameters from a server via a wireless network. A wireless transceiver may be operably coupled to the at least one processor, and the at least one processor may be further configured to obtain the pump timing parameters from a mobile device via a wireless communication protocol. A wireless transceiver may be operably coupled to the at least one processor, and the at least one processor may be further configured to provide the pump timing parameters to a server via a wireless network.

An example of a method of controlling a chemical dispersal device according to the disclosure includes determining an application value associated with a utilization of the chemical dispersal device, determining pump timing parameters based at least in part on the application value, and operating a pump based on the pump timing parameters, such that the pump is operably coupled to an electronic driver module and configured to deliver a chemical to an area external from the chemical dispersal device.

Implementations of such a method may include one or more of the following features. The method may include determining one or more environment values associated with the utilization of the chemical dispersal device, and determining the pump timing parameters based at least in part on the one or more environment values. The method may include determining an activity value associated with the utilization of the chemical dispersal device, and determining the pump timing parameters based at least in part on the activity value. Determining the pump timing parameters may include obtaining the pump timing parameters from a server via a wireless network. Operating the pump based on the pump timing parameters may include providing the pump timing parameters to the electronic driver module via a wireless communication protocol.

An example of a digitally controlled pump system according to the disclosure includes a housing, a pump disposed within the housing, the pump including an input and output, a plurality of air bladders fluidly connected to the pump output, at least one motion sensor, an electronic driver module operably coupled to the pump and the at least one motion sensor, the electronic driver module including at least one processor configured to determine an activity value based on a signal provide by the at least one motion sensor, set pump timing parameters based at least in part on the activity value, and activate the pump based on the pump timing parameters.

Items and/or techniques described herein may provide one or more of the following capabilities, as well as other capabilities not mentioned. A digitally controlled, wearable or stationary chemical dispersal device using a pump and activity-based or environmental-based feedback monitoring is described. The system contains a liquid chemical reservoir which can be replaced or refilled for multi-use operation. Electronic controls are used to drive the pump's liquid or air flow rate periodically with user control features and/or monitored, embedded digital sensors. Feedback from the sensors monitoring either the activity of a wearer of the device or the local environment can be used to adjust the pump's flow rate automatically. In addition, user selectable operation mode via Bluetooth is also described. The pump system can be configured for either liquid-based or air-based delivery operation. In the liquid-based configuration, a chemical solution is pumped from a reservoir through the pump to the exit orifice of the system for dispersal. In the air-based pump configuration, the output of the pump delivers a stream of air to facilitate directional evaporation of a chemical reservoir towards the exit orifice. A general method based on the digital activity monitoring of the device is described. As a specific example, the device can be designed to be integrated within a companion animal collar, harness, vest or other wearable or stationary device. For such a companion animal application, the system can be further configured to disperse a non-toxic attractant for subsequent trapping of harmful pests such as ticks.

### BRIEF DESCRIPTIONS OF THE DRAWINGS

In the appended figures, similar components and/or features may have the same reference label.

FIG. 1 is an example of a digitally controlled chemical dispersal system operating in positive pressure air flow mode.

FIG. 2 is an example digitally controlled chemical dispersal system operating in positive pressure air flow mode with a chemical reservoir and a replaceable trap module.

FIG. 3 is an example digitally controlled chemical dispersal system operating in negative pressure liquid flow mode with a primary chemical reservoir and a secondary chemical reservoir.

FIG. 4 is an example digitally controlled chemical dispersal system operating in negative pressure liquid flow mode with two chemical reservoirs, and replaceable trap module.

FIG. 5 is an example digitally controlled chemical dispersal system operating in negative pressure liquid flow and positive pressure air flow mode for dual pumps with two chemical reservoirs.

FIG. 6 is an example digitally controlled chemical dispersal system operating in negative pressure liquid flow and positive pressure air flow mode with dual pumps, two chemical reservoirs, and a replaceable trap module.

FIG. 7 is an example digitally controlled chemical dispersal system operating in negative pressure liquid flow mode with a combination chemical reservoir and dispersal orifice.

FIG. 8 is an example digitally controlled chemical dispersal system operating in negative pressure liquid flow mode with a combination chemical reservoir and dispersal orifice and an attachable trap module.

FIG. 9 is an example digitally controlled chemical dispersal system operating with dual pumps and a combination chemical reservoir and dispersal orifice.

FIG. 10A is an example digitally controlled chemical dispersal system operating with dual pumps, a combination chemical reservoir and dispersal orifice, and a replaceable trap module.

FIG. 10B is an example digitally controlled chemical dispersal system including a heater module.

FIG. 11 is an example electronic timing diagram for a digitally controlled chemical dispersal system.

FIG. 12 is an example insect trap utilizing a digitally controlled chemical dispersal system.

FIG. 13A is a system architecture diagram of an example network to receive and distribute control variables for one or more digitally controlled chemical dispersal systems.

FIG. 13B is a system architecture diagram of an example network of digitally controlled chemical dispersal systems for trapping bedbugs.

FIG. 14 is an example process flow diagram for a method of setting pump timing parameters.

FIG. 15 is an example data structure for setting pump timing parameters.

FIG. 16 is an example of a digitally controlled air pump system operating in positive pressure air flow mode with integrated air bladders.

FIG. 17 is an example of a multiple-pump configuration for a digitally controlled air pump system operating in positive pressure air flow mode with integrated air bladders.

### DETAILED DESCRIPTION

The following description is provided to illustrate a potential application and use case for the invention but does not limit the invention. In the case of a companion animal wearing the device equipped with a chemical attractant and trap module, the modulation of the pump's optimal duty cycle can be controlled by embedded sensors monitoring the animal's activity. The chemical attractant is supplied within the device to provide an alternative, volatilized attractant to that naturally provided by the companion animal's exhaled breath. Therefore, with high companion animal activity (e.g., increased respiration), a sensor can send signals to the electronic module controlling the air pump and modulate the pump with a higher duty cycle to increase attractant volatilization. This pump modulation based on activity feedback might be desirable to adequately compete with the larger exhalation gradient of the companion animal during higher respiration activity. Once the activity of the companion animal diminishes, the sensor can send updated signals to the pump via the electronic control module and decrease the duty cycle of the pump providing an optimal balance of chemical attractant volatilization and power consumption.

Monitoring the activity of the wearer of this device or the environment of device lends itself to many applications where optimized or customized chemical dispersion may be required or useful.

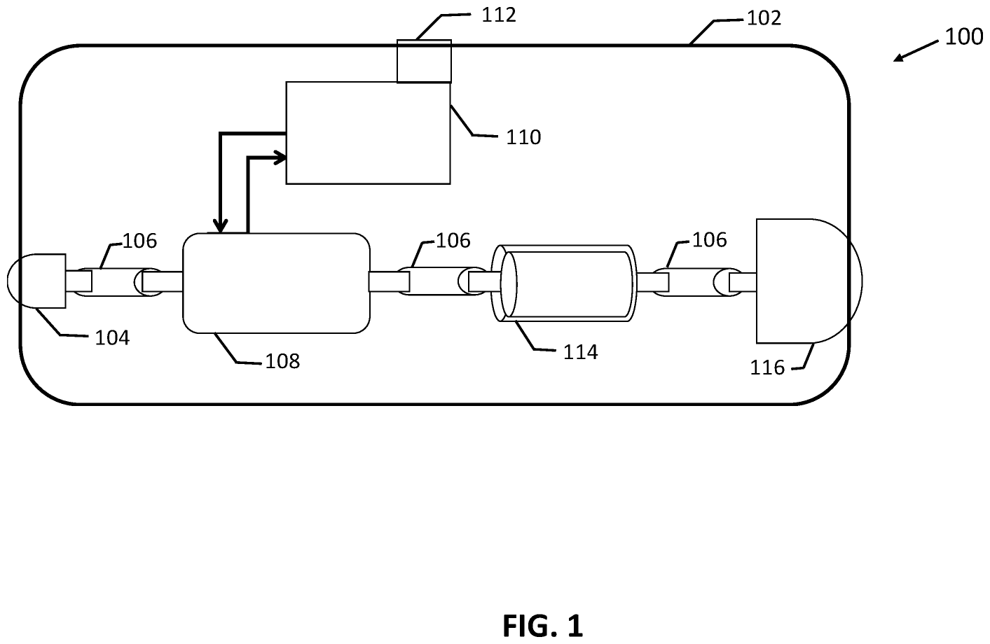

Referring to FIG. 1, a digitally controlled, activity- or environmental-based chemical dispersal system 100 operating in positive pressure air flow mode for pump is shown. As used herein, the term “activity-based” will be used with the understanding that activity-based, environmental-based, or user-based control of the system are all possible. The system 100 includes an outer housing 102 containing multiple subcomponents. An optional air filter 104 may be connected to the input of the digitally controlled pump 108 via tubing 106. In an example, the air filter 104 may contain a stainless steel screen with mesh holes ranging in size from 5 to 100 microns and barb fittings ranging from 1/16″ to ⅛″ to accommodate tubing connections. The overall length for the air filter may range from ½″ to 1¼″. The pump 108 may be driven and powered by a battery-powered electronic driver module 110 which may be configured with a rechargeable battery requiring a connector 112 emanating from the external housing 102. The output of the pump 108 is connected to the input of a chemical reservoir 114. In an embodiment, the pump may typically operate with a flow rate between 1 milliliter/min to 500 milliliter/min, a back pressure between 50 and 800 millibars, and an operating current between 10 and 500 milliamps. The chemical reservoir may include various geometric shapes, including but not limited to, a cylinder, box, sealed pouch, or other receptacles capable of holding a liquid. In an example, a cylinder with a diameter ranging between ⅛″ to ¾″ and a length ranging from ½″ to 2″ may be used. The chemical contained within the reservoir 114 can be a single compound or a mixture of chemical compounds. Once positive pressure air flow is established by the pump 108, directional air flow into and through the chemical reservoir 114 acts to volatilize chemicals which exit the reservoir into an optional chemical dispersal orifice 116. The chemical reservoir 114 may contain an absorbent material to optimize volatilization rate performance for the chemicals. In an example, the absorbent material may include sintered porous materials such as ultra-high molecular weight polyethylene (UHMWPE), high density polyethylene (HDPE), polyurethane foam, and other porous foam or sponge materials composed of open pores whose cavities are connected allowing fluidic conduction throughout the material. The exit of the chemical reservoir 114 may also act as the chemical reservoir dispersal orifice. In general, the chemical dispersal orifice is configured to transport the volatilized chemicals to the exterior of the chemical dispersal system. In an example, the chemical dispersal orifice may deliver volatilized chemicals into the periphery of the wearer's head so that the chemicals are sensed by the wearer. The orifice itself may be a single opening with a cross sectional area ranging from 0.001 in² to 0.785 in² or be comprised of multiple openings with a total cross sectional area ranging from 0.002 in² to 0.785 in². In an example, some subcomponents may also be connected to each other by tubing 106. Other manufacturing techniques such as 3D printing or molding may be used to construct the system such that the need for tubing 106 is reduced or eliminate.

As an example only, and not a limitation, the chemical reservoir 114 may be filled with an attractant based on naturally occurring chemical compounds found in or produced by mammals, for example, salt, water, acetone, nitric oxide, acetic acid, guanine, xanthine, hypoxanthine, adenine, inosine, 8-azaguanine, squalene, 2-nitrophenol, benzoic acid, butanoic acid, methylbutanoic acid, methylpropanoic acid, pentanoic acid, nonanoic acid, methyl salicylate, salicylaldehyde, hematin, carbon dioxide, octenol, ammonium carbonate, 2,6-dichlorophenol, phenylacetaldehyde, amino acids, urea, uric acid, benzaldehyde, hexanal, heptanal, pyruvate, 3-pentanone etc., or combinations thereof The constituent ratio of attractants may be, for example, 1-2 parts octenol, 5-10 parts squalene, 5-10 parts nitrophenol, 10-20 parts methyl salicylate, 10-20 parts butanoic acid, 10-20 parts nononoic acid, 10-20 parts guanine, and 10-20 parts xanthine. Other compounds may be disposed in the chemical reservoir 114.

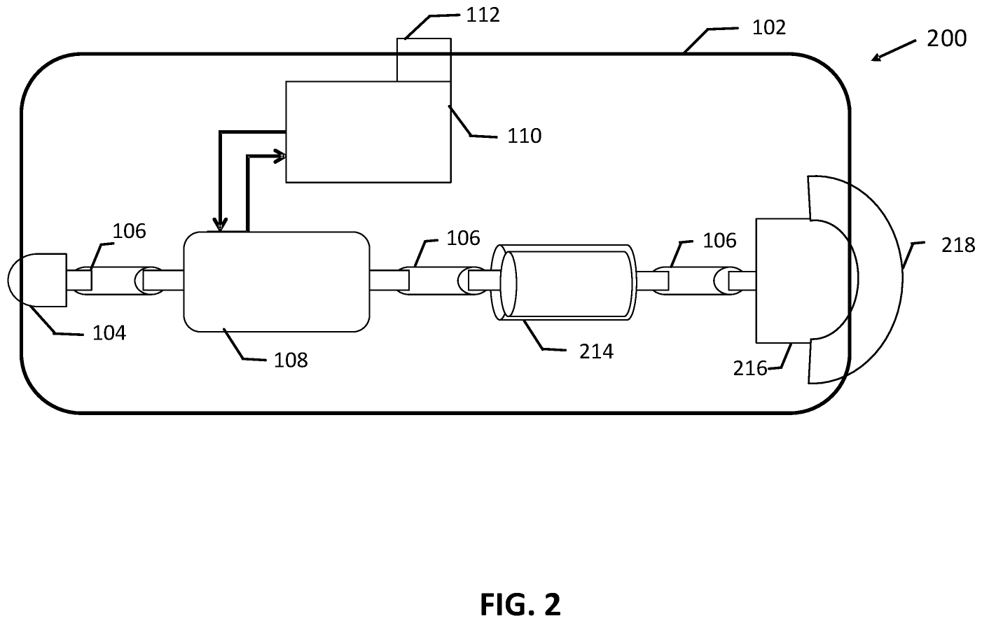

Referring to FIG. 2, a digitally controlled, activity-based chemical dispersal system 200 operating in positive pressure air flow mode for pump 108 with chemical reservoir 114 and replaceable trap module added is shown. The system 200 has similar functionality and components as described for system 100 excepting a removable trap module 218 has been added. This trap module may impact the configuration and design intent of both the chemical reservoir 214 and chemical dispersal orifice 216 owing to certain attachment features which may be present for coupling to the removable trap module 218. In an example, the removable trap module may contain male snap features coupling to receiving female snap features to temporarily affix the trap module to the chemical dispersal orifice. The removable trap module may contain an immobilizing layer to hold the pest once contact with the immobilizing layer is established by the pest. This immobilizing layer may contain an adhesive or other physical entanglement substrate designed to immobilize the legs or other body parts of the pest. The removable trap feature may contain a porous sheath to simultaneously protect the adhesive or other immobilizing layer from the environment and allow conveyance of the pest to the adhesive layer. Once one or more pests are immobilized within the trap, the trap module 218 can be removed and replaced by a new trap module.

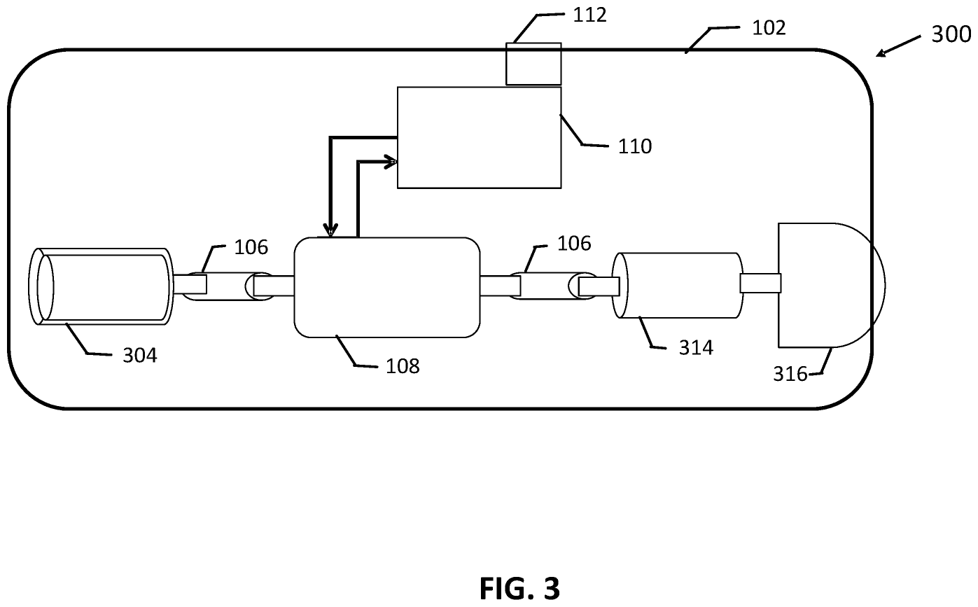

Referring to FIG. 3, a digitally controlled, activity-based chemical dispersal system 300 operating in negative pressure liquid flow mode for pump with primary chemical reservoir and a secondary chemical reservoir is shown. In this embodiment, the system 300 is configured such that a liquid chemical is withdrawn from the primary chemical reservoir 304 due to negative pressure applied from the pump 108. Once the chemical liquid passes through the pump 108, the positive pressure output pushes the chemical liquid into the secondary chemical reservoir 314. The secondary chemical reservoir 314 may contain a porous absorbent media to receive the chemical liquid from the primary chemical reservoir 304. Depending on the digital signals received from the electronic driver module 110, the primary chemical reservoir may be fully or partially transferred to the secondary chemical reservoir 314. Chemical volatilization from the system is similar to that described in the previous systems 100, 200.

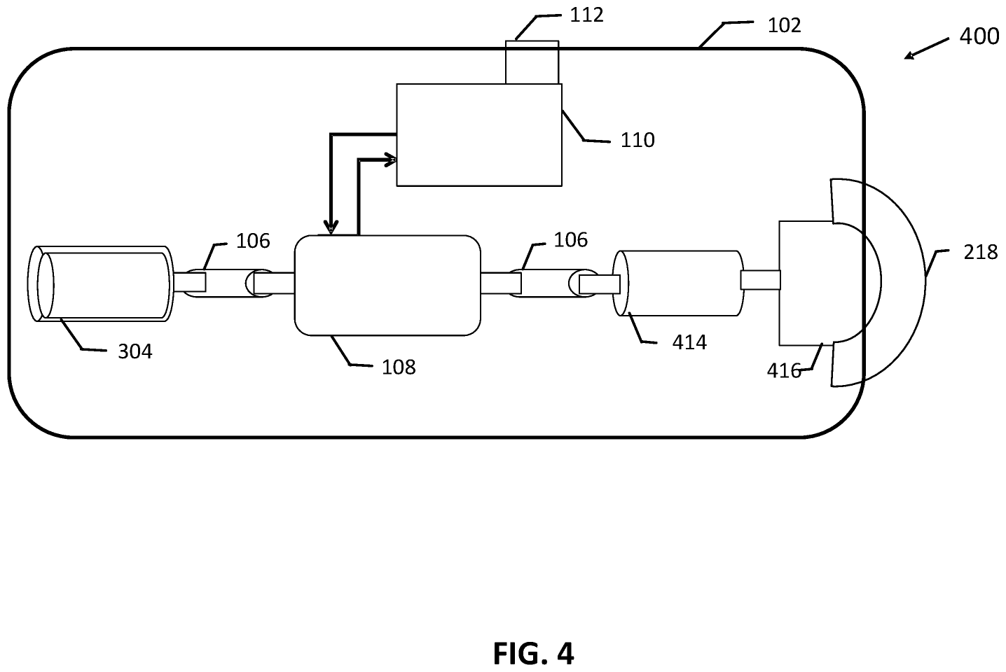

Referring to FIG. 4, a digitally controlled, activity-based chemical dispersal system 400 operating in negative pressure liquid flow mode for pump with two chemical reservoirs, and replaceable trap module added is shown. The system 400 has similar functionality and components as described for system 300 excepting a removable trap module 218 has been added. As described for the system 200 above, this trap module may impact the configuration and design intent of both the secondary chemical reservoir 414 and chemical dispersal orifice 416 owing to certain attachment features which may be present for coupling to the removable trap module 418.

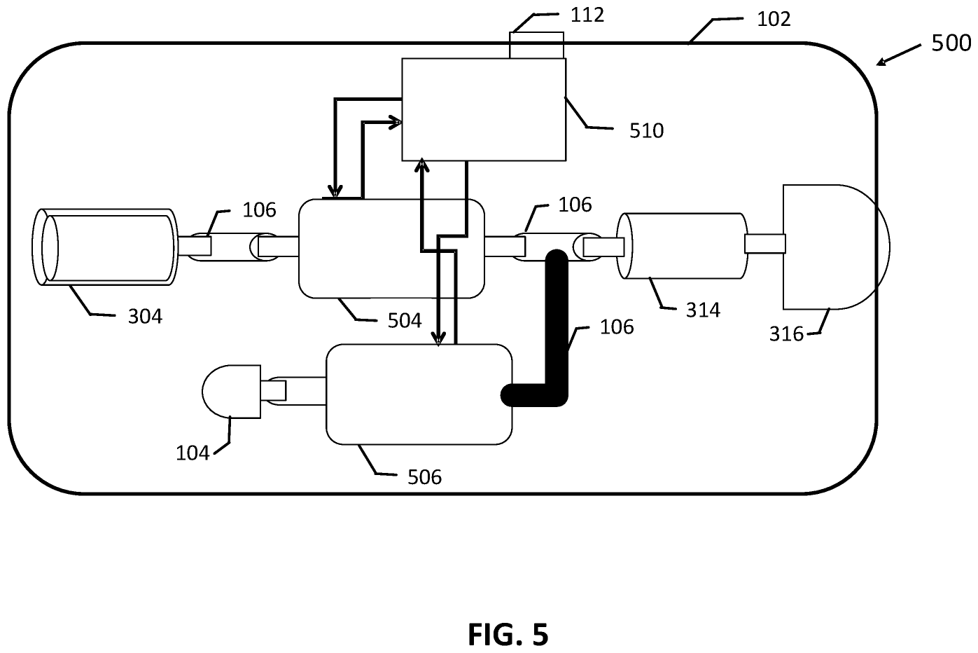

Referring to FIG. 5, a digitally controlled, activity-based chemical dispersal system operating in negative pressure liquid flow and positive pressure air flow mode for dual pumps with two chemical reservoirs is shown. The system 500 includes a first pump 504 configured to apply negative pressure to partially or fully empty primary chemical reservoir 304 based on digital signals received from the electronic driver 510. The positive pressure output of the pump 504 pushes the liquid chemical into the secondary chemical module 314. Based on additional signals received from the electronic driver 510, a second pump 506 may apply positive pressure to facilitate volatilization of the chemicals within the secondary chemical reservoir module 314.

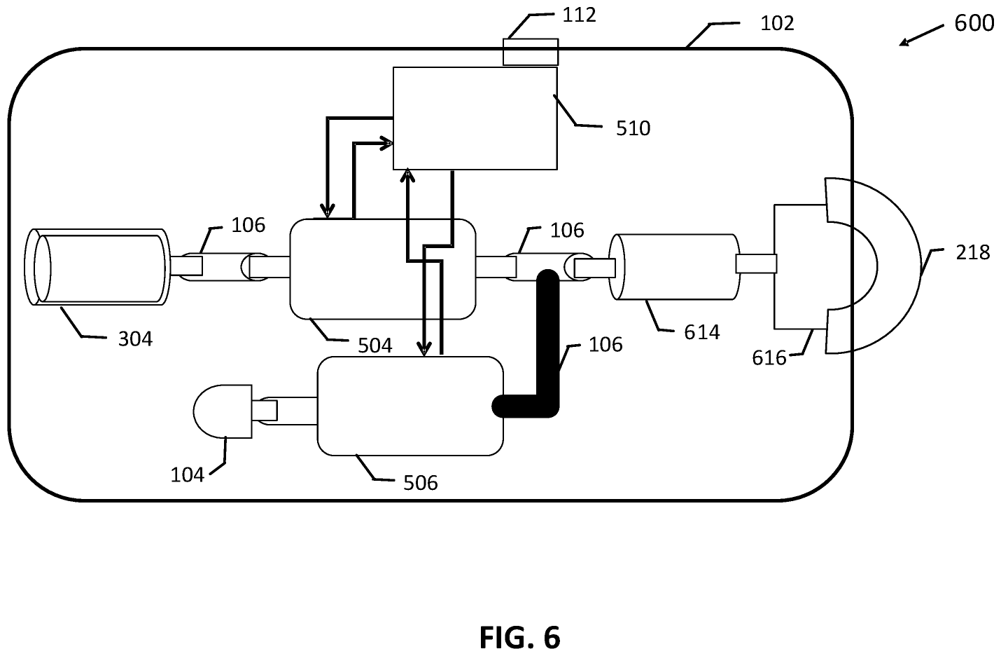

Referring to FIG. 6, a digitally controlled, activity-based chemical dispersal system 600 operating in negative pressure liquid flow and positive pressure air flow mode for dual pumps with two chemical reservoirs, and a replaceable trap module is shown. The system 600 has similar functionality and components as described for system 500 excepting a removable trap module 218 has been added. As described for the systems 200 and 400 in FIG. 2 and FIG. 4, respectively, this trap module 218 may impact the configuration and design intent of both the secondary chemical reservoir 614 and chemical dispersal orifice 616 owing to certain attachment features which may be present for coupling to the removable trap module 218.

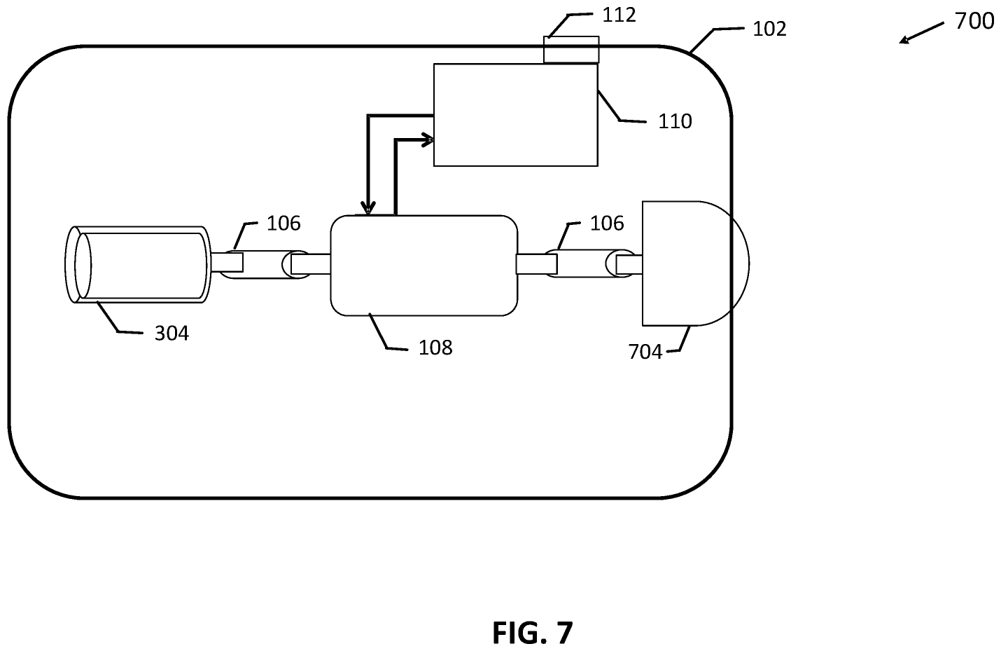

Referring to FIG. 7, a digitally controlled, activity-based chemical dispersal system 700 operating in negative pressure liquid flow mode for pump with a combination chemical reservoir and dispersal orifice. The system 700 is similar to system 300 described in FIG. 3 excepting that the chemical reservoir 314 and chemical dispersal orifice 316 of embodiment 300 in FIG. 3 have been combined into an integrated chemical reservoir and chemical dispersal orifice 704 which permits chemical dispersal to the external environment of the system 700.

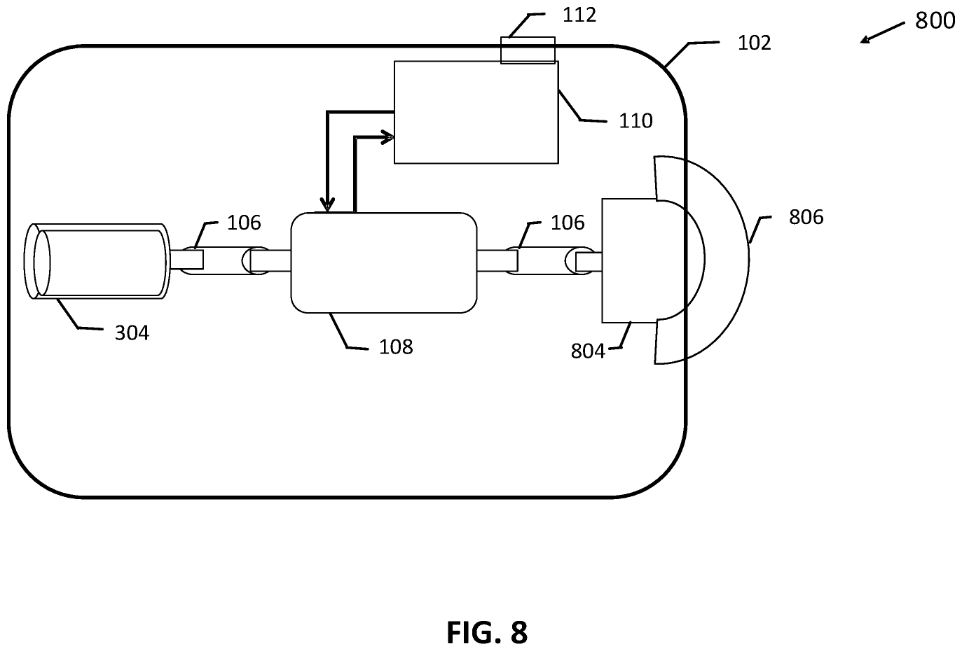

Referring to FIG. 8, a digitally controlled, activity-based chemical dispersal system operating in negative pressure liquid flow mode for pump with combination chemical reservoir and dispersal orifice and an attachable trap module is shown. The system designated as 800 has similar functionality and components as described for system 700 excepting a removable trap module 218 has been added. As described for the systems 200, 400, and 600 in FIGS. 2, 4 and 6, the trap module 218 may impact the configuration and design intent of both the secondary chemical reservoir 814 and chemical dispersal orifice 816 owing to certain attachment features which may be present for coupling to the removable trap module 218.

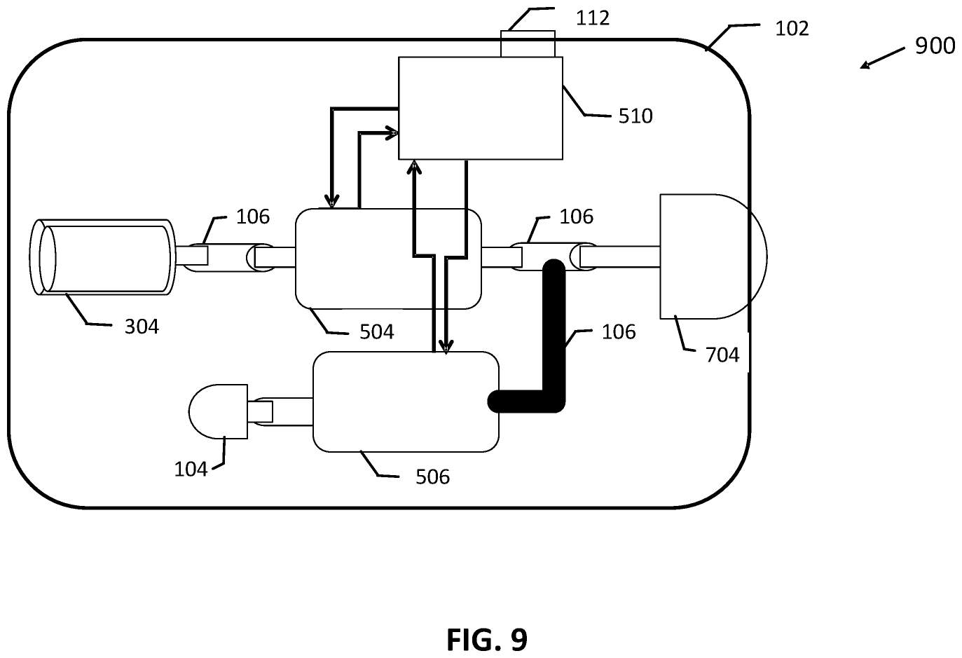

Referring to FIG. 9, a digitally controlled, activity-based chemical dispersal system 900 operating with dual pumps and a combination chemical reservoir and dispersal orifice is shown. The system 900 is similar to system 500 described in FIG. 5 excepting that the chemical reservoir 314 and chemical dispersal orifice 316 of embodiment 500 in FIG. 5 have been combined into an integrated chemical reservoir and chemical dispersal orifice 704.

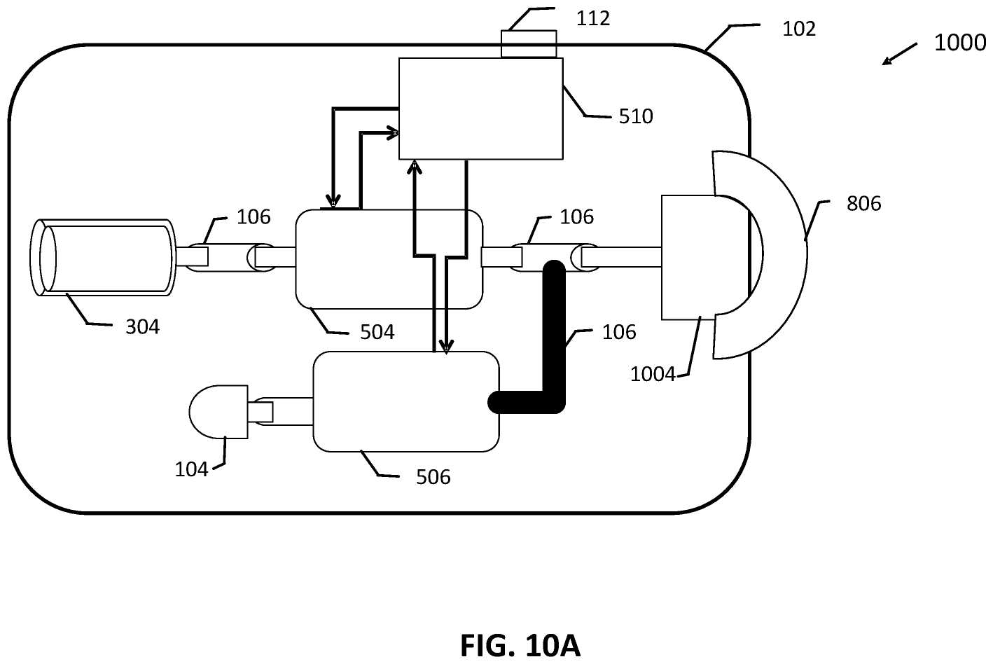

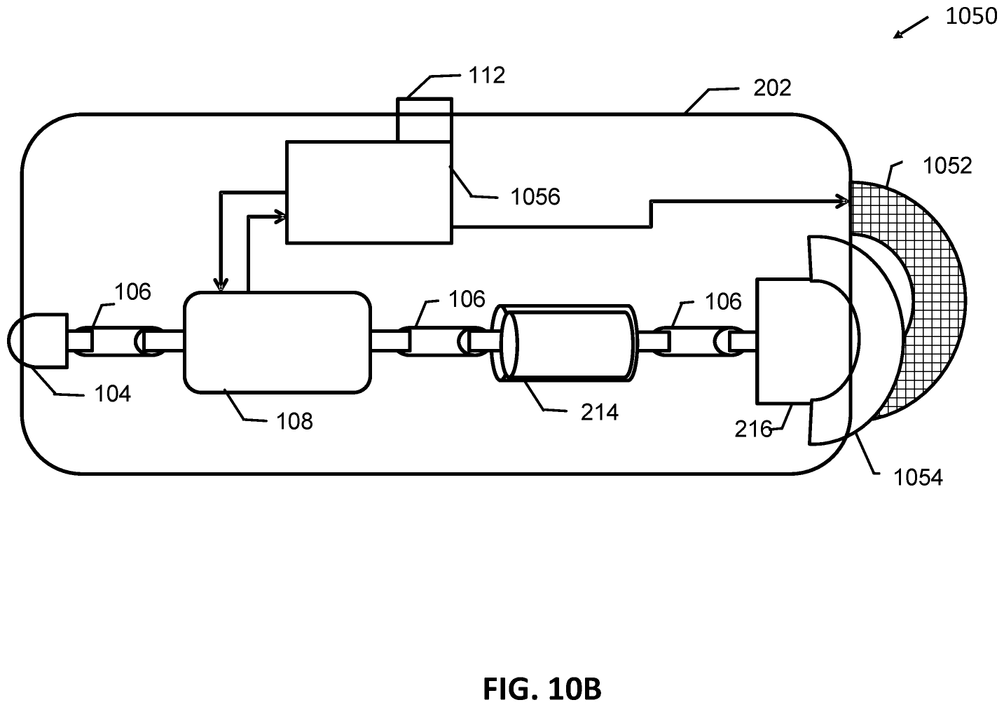

Referring to FIG. 10A, a digitally controlled, activity-based chemical dispersal system operating with dual pumps, a combination chemical reservoir and dispersal orifice, and a replaceable trap module is shown. The system 1000 is similar to system 600 described in FIG. 6 excepting that the chemical reservoir 614 and chemical dispersal orifice 616 of embodiment 600 in FIG. 6 have been combined into an integrated chemical reservoir and chemical dispersal orifice 1004 with an attached replaceable trap module 806.

Referring to FIG. 10B, a digitally controlled, activity-based chemical dispersal system 1050 operating in positive pressure air flow mode for pump with chemical reservoir, replaceable trap module, and heater module added is shown. In this embodiment, a heater module 1052 is driven by the digital control module 1056 to produce an additional attractant in the form of heat. In an embodiment, the heater module may be comprised of a metallic screen with an area ranging between 0.016 and 3.0 in² and with an operating current between 0.05 and 1 amperes. The heater module will typically operate within a temperature range between 30 and 75 degrees Celsius. The optional heater module 1052 is placed proximal to the replaceable trap module 1054 and may be mechanically joined to either the replaceable trap module 1054, the chemical dispersal orifice 216, or the outer housing 202 or any combination thereof. The heater module 1052 can be controlled similarly to the pump in previous descriptions, i.e., the heater's cycle time may be variable and controllable from activity-based sensors or other user inputs. For example, the system 1050 may be similar to one of the previously described systems 200, 400, 600, 800, 1000 with the exception that an optional heater 1052 is added proximal to the replaceable trap module 1054.

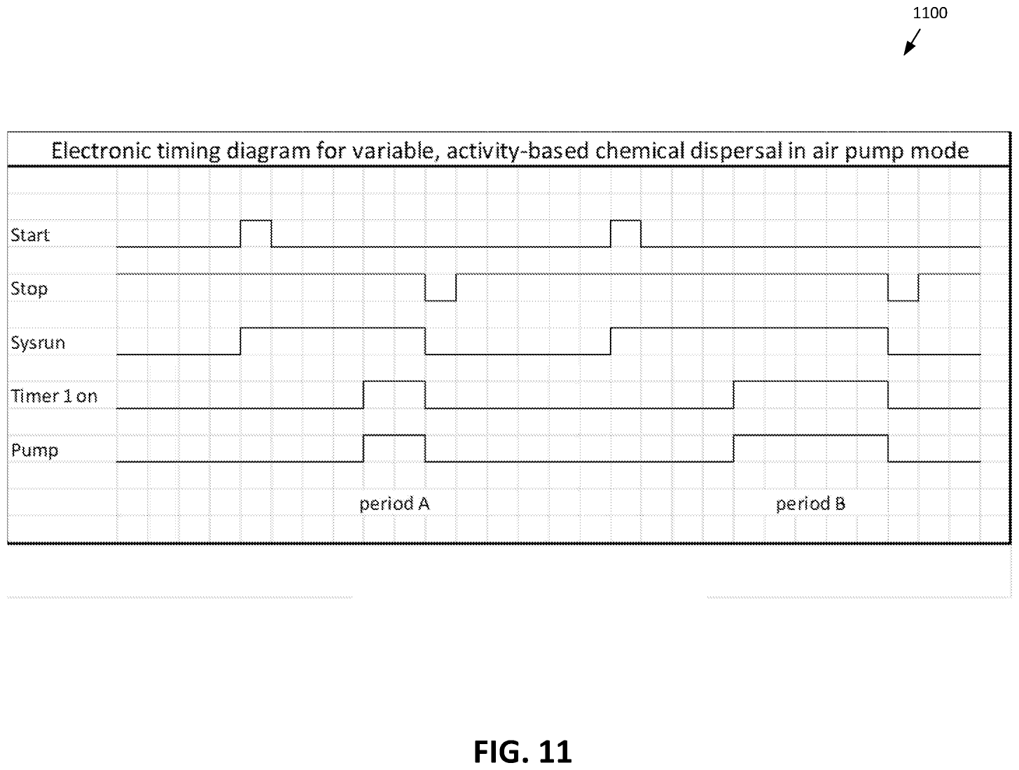

Referring to FIG. 11, an example electronic timing diagram 1100 for a digitally controlled chemical dispersal system is shown. The diagram 1100 is exemplary only and not a limitation. In general, the electronic driver module 110 may be configured to operate the pump 108 based on timing information stored in the electronic driver module 110 and/or received from a communications link. The pump timing information may be loaded into the electronic driver module 110 at the time of manufacture. In an example, the electronic driver module 110 may include at least one processor, sensors and a communications module. In an example, the electronic driver module 110 may include an Internet of Things (IoT) chipset (e.g., Qualcomm MDM9207 IoT Modem) including a radio transceiver configured to send and receive information over a wireless communication protocol such as 3G/4G LTE/5G, WiFi and BLUETOOTH. In an example, the IoT chipset may include GNSS navigation capabilities. The communication module may be paired with a mobile device such as a smartphone, a tablet, a computer, or other network enabled device, and the electronic driver module 110 may be configured to receive and store timing information received from the mobile device. The timing information may include one or more active and rest periods of different durations and cycles. Different timing profiles may be associated with the current environment or activity of the digitally controlled chemical dispersal system. For example, a “pump on” parameter of a timing profile may be based on the size of the user. That is, if the dispersal system is integrated in a dog collar, then the “pump on” value may be relatively longer for a large dog than for a smaller dog. Similarly, the current activity of the dog may impact a “pump off” parameter such that the pump will be off for a relatively longer period is a dog is inactive (e.g., sleeping). One or more motion sensors (e.g., accelerometers, Hall-effect sensors, gyroscopes) in the electronic driver module 110 may be used to determine the relative activity based on the sensed motion. In an example, a 3D accelerometer and 3D gyroscope chip, such as the ST LSM6DSL may be operably coupled to an IoT chip set via a serial interface (e.g., I2C/SPI) and configured to provide motion information to a mobile device management module in the IoT chip set.

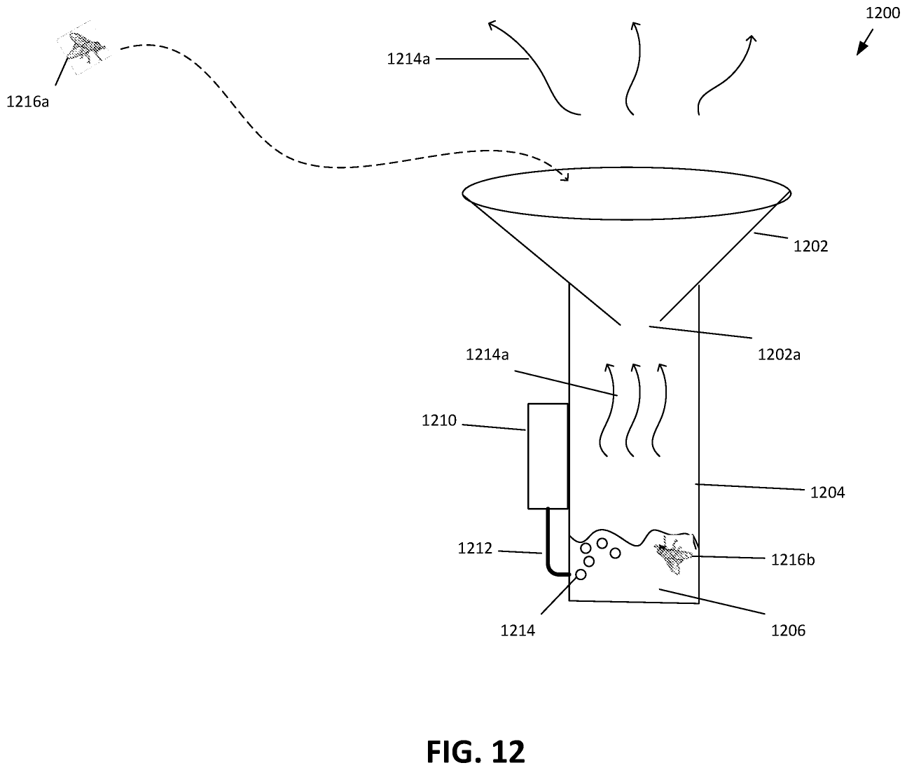

Referring to FIG. 12, an example insect trap 1200 utilizing a digitally controlled chemical dispersal system 1210 is shown. In an example, the insect trap 1200 may be approximately 6-10 inches tall, with a maximum diameter of approximately 3-6 inches. Other sizes and form factors may be used. The insect trap 1200 includes a detachable cover 1202 disposed on a trap chamber 1204. In an example, the detachable cover 1202 may be funnel shaped with a wide opening and a restricted area 1202a configured to prevent, or at least impede, an insect from exiting from the inside of the trap chamber 1204. A digitally controlled chemical dispersal system 1210 may be operably coupled to the trap chamber 1204 such that volatized chemicals may flow from the system 1210 through a connection hose 1212 and into the trap chamber. For example, the system 1210 may be similar to one of the previously described systems 100, 200, 300, 400, 500, 600, 700, 800, 900, 1000 with the exception that the respective dispersal and trap structures are replaced by the trap chamber 1204. In an example, a liquid 1206 may be optionally disposed in the trap chamber 1204. The liquid 1206 may be water with a small amount of dish water soap added to reduce the surface tension. In an example, sugar or other attractants may be added to the liquid 1206. In operation, the digitally controlled chemical dispersal system 1210 provides air containing volatilized chemical attractants into the trap chamber 1204. When the liquid 1206 is present, the air may create bubbles 1214 within the liquid 1206. Dispersal system 1210 creates a slight over-pressure within the trap chamber 1204 which enables the attractant 1214a (e.g., the content of the bubbles 1214) to flow through the trap chamber 1204 and exit the detachable cover 1202. A live insect 1216a may be drawn to the attractant 1214a emanating from the insect trap 1200 and then follow the flow of attractant 1214a into the trap chamber 1204. If the liquid 1206 is present, the live insect 1216a may be transformed into a dead insect 1216b via drowning. The detachable cover 1202 may be removed (e.g., unscrewed or otherwise detached) to enable the dead insect 1216b and/or water to be removed from the trap chamber 1204. The liquid 1206 may also be replaced while the detachable cover 1202 is removed.

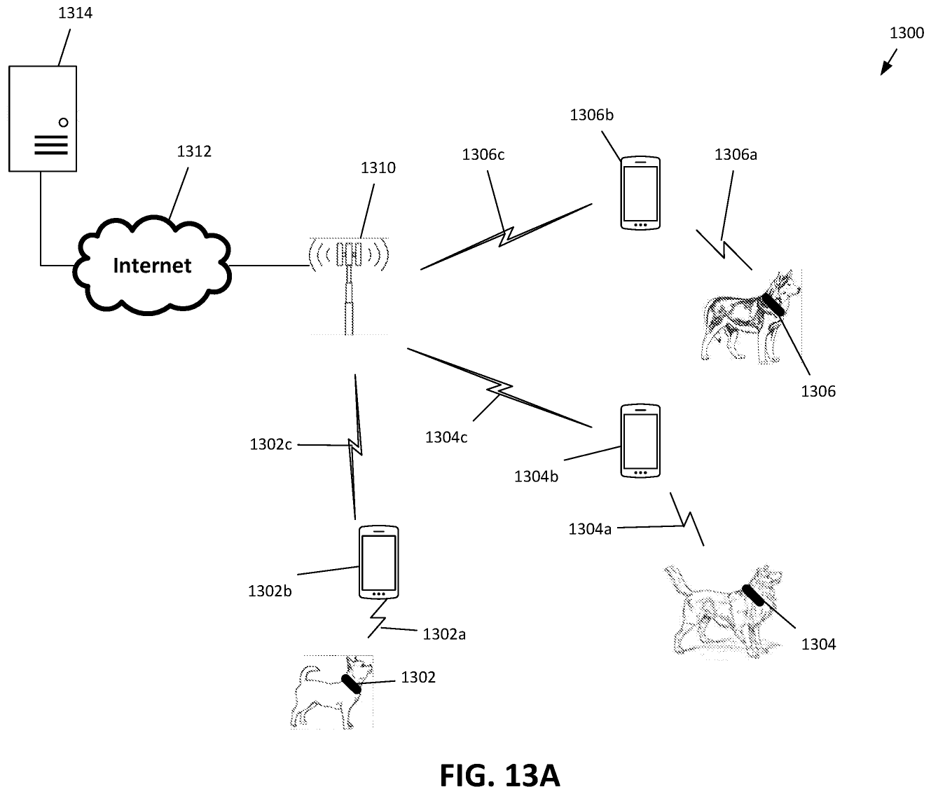

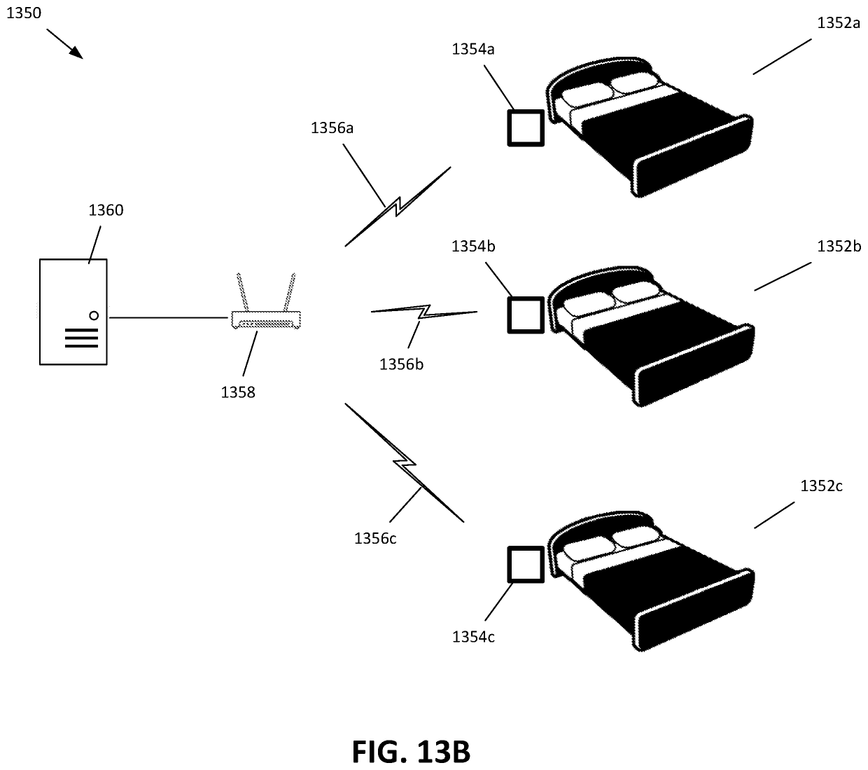

Referring to FIG. 13A, a system architecture diagram of an example network 1300 to receive and distribute control variables for one or more digitally controlled chemical dispersal systems. The network 1300 depicts a plurality of digitally controlled chemical dispersal systems configured as dog collars. The network 1300 may apply to other applications for the digitally controlled chemical dispersal system. Each of the digitally controlled chemical dispersal systems may be an Internet of Things (IoT) capable device, including an IoT chipset with at least one wireless transceiver, a mobile device manager and modem, and configured to communicate with a server 1314 via a wireless network such as mobile network (e.g., 3G, LTE, 5G, etc.), or other protocol such as Wi-Fi. The network 1300 includes a first digitally controlled chemical dispersal system 1302, a second digitally controlled chemical dispersal system 1304, and a third digitally controlled chemical dispersal system 1306. Each of the digitally controlled chemical dispersal systems 1302, 1304, 1306 includes a communication module such as a BLUETOOTH transceiver configured to communicate with a respective mobile device 1302b, 1304b, 1306b via a local communication link 1302a, 1304a, 1306a. Each of the mobile devices 1302b, 1304b, 1306b are configured to communicate with one or more base stations 1310 via a wide area communication link 1302c, 1304c, 1306c. In an example, the base station 1310 may be a cellular base station, access point, femto cell, or other transceiver configured to connect the mobile devices 1302b, 1304b, 1306b to the server 1314 via the internet 1312. The server 1314 may be one or more computer systems including one or more processors, memory devices and peripheral devices configured to receive, store and send control variables for the digitally controlled chemical dispersal systems.

In operation, a user interface application executing on a mobile device 1302b, 1304b, 1306b is configured to receive or determine information about the utilization/application of an associated digitally controlled chemical dispersal system 1302, 1304, 1306. For example, a user may enter the breed, size, hair length and age of the dog that is wearing the digitally controlled chemical dispersal system. A mobile device may be configured to current environmental conditions such as a location (e.g., lat/long/alt), time and date, speed, direction, and current environmental conditions based on sensors in the mobile device (e.g., accelerometers, temperature, barometric pressure sensor) or accessible via a web service (e.g., local weather status). The mobile device may also receive activity information from a paired digitally controlled chemical dispersal system. For example, the digitally controlled chemical dispersal system may include one or more motion sensors (e.g., accelerometers, gyros) configured to determine whether the dog is a rest, active, or highly active, as well as a moisture detector to determine if the dog is wet. The mobile device may be configured to select one or more pump parameters based on the application, environmental, and/or activity information. In an example a look-up table or similar data structure may persist on the mobile device or within the electronic driver module 110 to associate the application, environmental, and/or activity information with the pump timing parameters. In an example, the mobile device may be configured to query the server 1314 with the application, environmental, and/or activity information and receive the pump timing parameters from the server 1314. While FIG. 13A depicts a single server 1314, implementations may include multiple servers or cloud-based architectures such as Microsoft Azure® to receive, store and distribute application, environmental, activity information and/or pump timing parameters.

The network 1300 enables the customization of the pump timing parameters for wide range of applications, environments and activities. The timing parameters may be varied for different applications (e.g., pet collar, human wearer, stationary traps) including variations within an application (e.g., size, breed, user preferences, home use, restaurant, indoor, outdoor). The application may also include variations in the attractants disposed in the chemical reservoir. Regional, seasonal and temporal differences may also impact the pump parameters. For example, the pump-on duration may be increased during the hours of local dawn and dusk, or the pump-on duration may be decreased if the mobile device is moving faster than 10 mph (e.g., the user/dog is moving in a vehicle). Other relationships between the application, environmental, and/or activity information and the pump timing parameters may also be used. In an example, a user may provide feedback via a mobile device regarding the effectiveness of particular pump parameters for an application, environmental, and/or activity information. In this way, the pump timing parameters may be crowdsourced, and effective parameters may be identified and more effectively disseminated to other users.

Referring to FIG. 13B, a system architecture diagram of an example network 1350 of digitally controlled chemical dispersal systems for trapping bedbugs. The network 1350 depicts a plurality of digitally controlled chemical dispersal systems configured bed-side trapping systems (e.g., bedbug traps) such as the system depicted in FIGS. 1-10B. Each of the digitally controlled chemical dispersal systems are configured to communicate with a server 1360 via an access point 1358. The network 1350 includes a first bedbug trap 1354a, a second bedbug trap 1354b, and a third bedbug trap 1354c. That bedbug traps 1354a-c may be disposed proximal to, or on a respective bed 1352a-c. Each of the bedbug traps 1354a-c includes an IoT configured communication module such as a 3G, LTE, ethernet, BLUETOOTH or WiFi transceivers configured to communicate with one or more access points 1358 via a respective wired or wireless communication links 1356a-b. The server 1360 may be one or more computer systems including one or more processors, memory devices and peripheral devices configured to receive, store and send control variables for the digitally controlled chemical dispersal systems.

In operation, the bedbug traps 1354a-c may be configured to provide trap state information such as reservoir levels, attractant type, trap fill levels, power status, heater level, current pump parameters to the server 1360, and receive pump parameters and other information (e.g., BIOS updates, system settings, reporting parameters) from the server 1360. The bedbug traps 1354a-c may be configured to select one or more pump parameters based on the application, environmental, and/or activity information. In an example a look-up table or similar data structure may persist on the mobile device or within the electronic driver module 110 to associate the application (e.g., bedbug trap), environmental (e.g., temperature, humidity, ambient light), and/or current status of a respective bed 1352a-c (e.g., an activity) with the pump timing parameters. In an example, the bedbug traps 1354a-c may be configured to query the server 1360 with the current status of the bed, environmental, and/or application information and receive the pump timing parameters from the server 1360. While FIG. 13B depicts a single server 1360, implementations may include multiple servers or cloud-based architectures such as Microsoft Azure® to receive, store and distribute application, environmental, activity information and/or pump timing parameters.

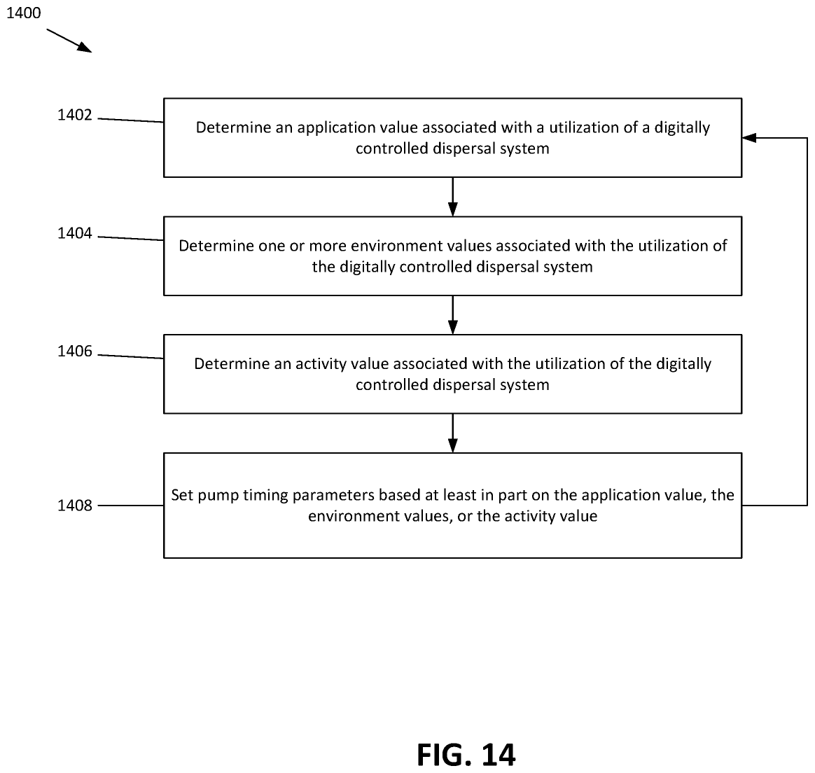

Referring to FIG. 14, with further reference to FIGS. 1-13, a method 1400 of setting pump timing parameters includes the stages shown. The method 1400 is, however, an example only and not limiting. The method 1400 may be altered, e.g., by having stages added, removed, rearranged, combined, performed concurrently, and/or having single stages split into multiple stages. For example, setting the pump timing parameters may be based on only one of the application value, the one or more environmental values, the activity value, or combinations thereof. In an example, the method 1400 may also be used to set parameters in other subcomponents within a chemical dispersal device, such as heater screen current, motion detection sensitivity, bleed valve pressure.

At stage 1402, the method includes determining an application value associated with a utilization of a digitally controlled dispersal system. A mobile device may be a means for determining an application value. A mobile device such as smart phone may be paired with a digitally controlled dispersal system via a local communication protocol such as BLUETOOTH or WiFi. The digitally controlled dispersal system may be configured for a particular application at time of manufacture. For example, a digitally controlled dispersal system may be configured for use as a pet collar, a static insect trap, or to be worn by a human, and the application value may be based on this type of use. The application value may also be based on more specific values associated with each use, such as type of attractant used, size, breed, hair length of a pet, or a user (as applicable). Other specific values of an application such as indoor or outdoor use, and/or individual or multiple traps in a location may be used to define an application for a static trap. Other categories and sub-categories to describe how a digitally controlled dispersal system is being used may be associated with an application value. Different pump timing parameters may be associated with the application. For example, a system configured as a pet collar may shorter pump on cycles at a higher pressure and shorter pump off periods (e.g., to accommodate for the pet moving). An insect trap, for example, may have longer pump on cycles at a low pressure and long pump off periods (e.g., activate at dawn and dusk). Different chemical and physical properties of the attractants may utilize different pump timing parameters (e.g., based on attractant volatility, viscosity, and other properties which may impact the dispersal pattern or persistence). Other application based pump timing parameters may be used to improve the efficiency of the dispersal system in a selected application. In general, the ability to associate the digitally controlled dispersal system with an application value enables the use of the same or similar hardware configurations in different applications and different markets.

At stage 1404, the method includes determining one or more environment values associated with the utilization of the digitally controlled dispersal system. A mobile device may be a means for determining the one or more environment variables. The environment values may relate to a current context of the digitally controlled dispersal system. For example, the current location, date, time and current weather conditions may be associated with environment values. Other context information such as the current speed, as well as ambient sounds and light intensity detected by sensors on the mobile device may be used to determine one or more environment variables. Other information available to the mobile device such as GPS position information, location tags (e.g., dog park, beach, hiking trail) and calendar entries may be used to determine the environment values. In general, the environment values describe where and when a digitally controlled dispersal system is being used.

At stage 1406, the method includes determining an activity value associated with the utilization of the digitally controlled dispersal system. The digitally controlled dispersal system may be a means for determining an activity value. The activity value may be based on current motion sensed by the digitally controlled dispersal system. The digitally controlled dispersal system may include one or more sensors configured to detect motion as well as other environmental variable unique to the digitally controlled dispersal system. For example, if the digitally controlled dispersal system is being worn by a dog that is running and the mobile device is being held by a user who is stationary, then activity value may indicate an active state. In general, the activity value indicates the context of the digitally controlled dispersal system which may be different from the context of the mobile device.

At stage 1406, the method includes setting pump timing parameters based at least in part on the application value, the environment values, or the activity value. The electronic driver module 110 in the digitally controlled dispersal system may be a means for determining and setting the pump timing parameters. The electronic driver module 110 may include at least one processor and memory (e.g., in an IoT chipset) configured to store and access a data structure containing the pump timing parameters and associated application values, the environment values, and the activity values. In an example, a plurality of pump timing parameters and associated activity values may be stored in the electronic driver module 110 at the time of manufacture. That is, the pump timing parameters may be based only on the activity values. In another example, a plurality of pump timing parameters and associated application, environment, and activity values may be stored in the electronic driver module 110 at the time of manufacture. In operation, the electronic driver module 110 may be configured to receive application and environment values from a networked system such as a mobile device or server (e.g., via BLUETOOTH, WiFi, etc.), and determine the pump timing parameters based on the previously stored values. In another example, a plurality of pump timing parameters and associated application, environment, and activity values may be received from a mobile device and stored in the electronic driver module 110 when the digitally controlled dispersal system connects with the mobile device. In another example, a mobile device may be configured to provide a plurality of pump timing parameters and associated activity values to the digitally controlled dispersal system based on the application and environment values determined by the mobile device.

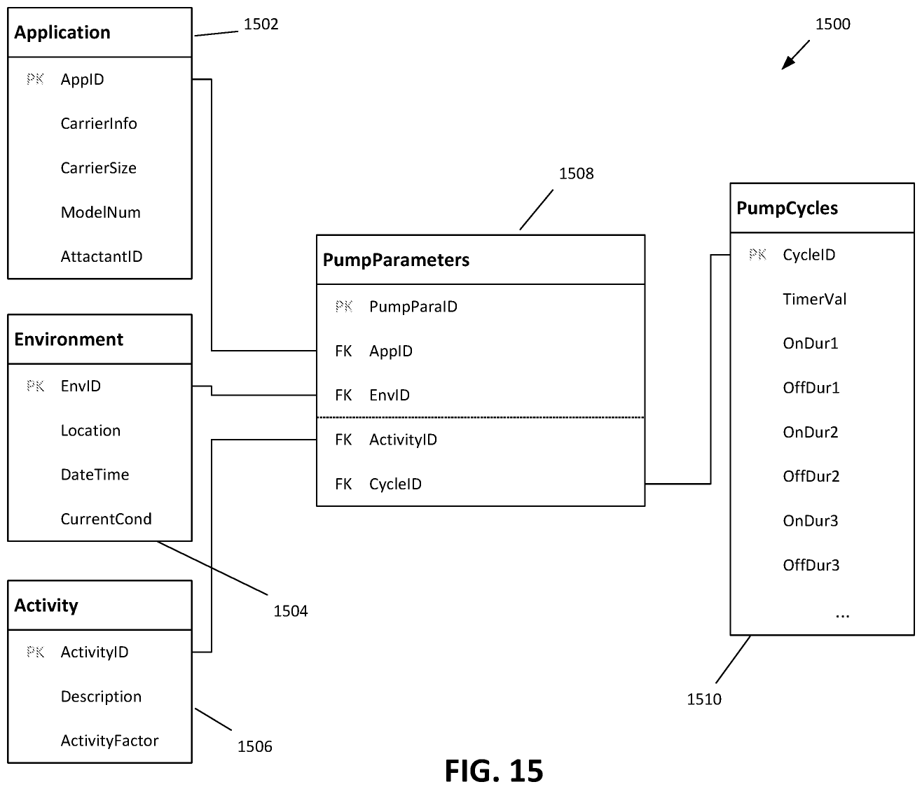

Referring to FIG. 15, an example data structure 1500 for setting pump timing parameters is shown. The data structure 1500 may be stored in one or more files such as XML, JSON, CSV or other data format. The classes and attributes depicted in FIG. 15 are examples only, and not limitations, as other classes and attributes may be used. For example, other classes associated with other subcomponent in a chemical dispersal device may be used (e.g., heater, motion sensitive, motion detection patterns). An applications class 1502 may include a primary key (AppID) and additional fields to categorized how a digitally controlled dispersal system is being utilized. Attributes may include information about the carrier of the digitally controlled dispersal system (e.g., dog, human, static trap), as well as the size of the carrier (e.g., large, small). Information about the digitally controlled dispersal system model number and attractant in use may also be used. Other application attributes may also be included in the application class 1502.

An environment class 1504 may include a primary key value (EnvID) as well as attributes to describe where and when the digitally controlled dispersal system is being used. For example, a location attribute, a DateTime attribute and a Current Conditions attribute may be included in the environment class 1504. Other environment related information may also be stored as attributes in the environment class 1504.

An activity class 1506 may include a primary key (ActivityID) as well as attributes to indicate the current context of the digitally controlled dispersal system. For example, a description attribute may be associated with an activity level (e.g., low, medium, high), or other state such as wet or dry. An activity factor attribute may be used as a relative reference between activity states. In an example, the activity factor attribute may be based on patterns of motion detected by one or motion detectors (in one or more axes) over time. The data structure may include a motion class including time based motion detection signals, and the activity factor may be determined by convolving a current motion detection signal with one or more signals in motion class. Other pattern matching and search methods may also be used to classify a current motion signal.

A pump cycles class 1510 includes a primary key (CycleID) and a plurality of attributes configured to generate pump timing parameters such as depicted in FIG. 11. For example, the attributes may include a plurality of pump-on and pump-off values and timing values. Alternatively, the pressurizing system may be configured or programmed to operate in alternating positive and negative pressure modes to provide a changing sensation experiences at the surface of the animal.

A pump parameters class 1508 includes a primary key value (PumpParaID) and a foreign keys associated with the application class 1502, the environment class 1504, the activity class 1506, and the pump cycles 1510. The foreign key values may be null to indicate that not every class is required to correlate the pump timing parameters with at least one class attribute.

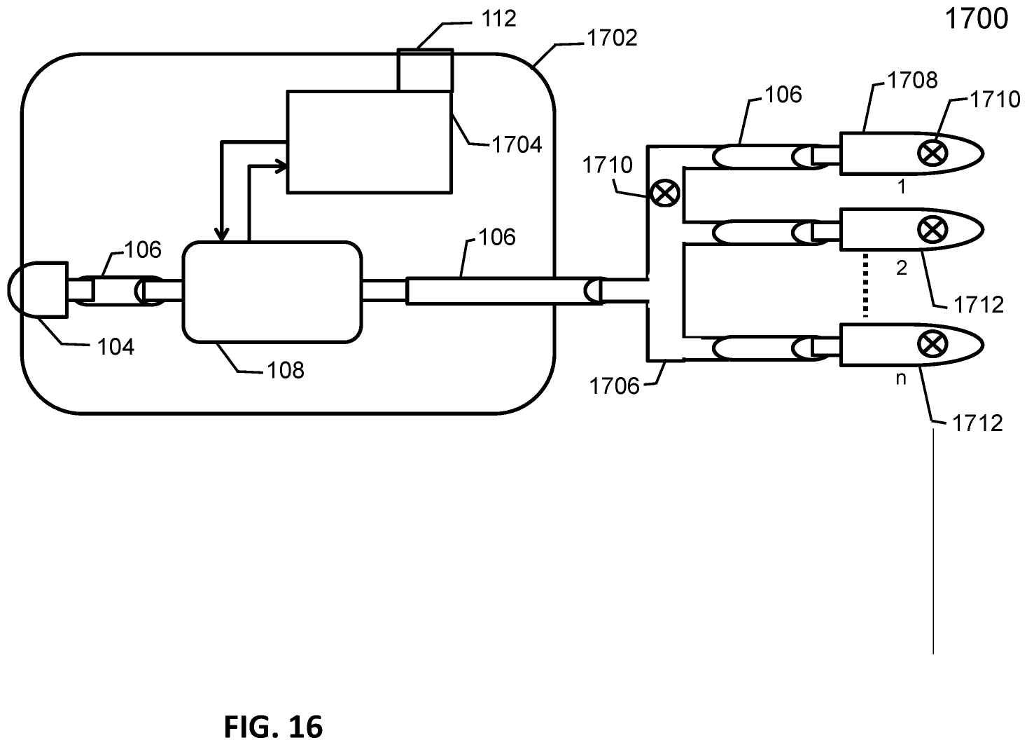

Referring to FIG. 16 a digitally controlled, activity-based pump system 1700 operating in positive pressure air flow mode with an air manifold and air bladders is shown. The electronic driver module 1704 may include an IoT chipset and at least one sensor for detecting activity (e.g., motion) of or environmental conditions surrounding the wearer of the device. In an example, motion sensors may be ST LSM6DSL chips configured to provide signals to the IoT chipset via interrupt channels (e.g., INT1/pin4, INT2/pin9) or via a serial communication link (e.g., I2C/SPI) Based on motion sensor input, the pump is activated to direct positive air flow through a manifold 1706 and then inflate one or more air bladders indicated as 1708 in a singular air bladder configuration or as 1712 in a multiple air bladder configuration. Each air bladder for the device may contain an integrated air bleed off module 1710. The integrated air bleed off module 1710 can be designed to bleed off or release air at a very slow rate or a relatively rapid rate depending on desired application intent. In such a dual pump pressurizing system, alternating a pump in positive pressure mode with the second pump operating in negative pressure mode can provide a set of changing sensation experiences at the surface of the animal. In an example, the driver module may include an IoT chipset configured to communication on a wide area network (e.g., 3G, LTE, 5G) or a local area network (e.g., Wi-Fi, Bluetooth). The IoT chipset may be used to send and receive pump parameters and other state information such as bladder pressure, location, battery level associated with the activity-based pump system 1700.

The air bladders 1708, 1712 may be combined with a compression garment such as a vest, oversized collar, or wrap configured to fit tightly on an animal. The animal may be, for example, a dog and the bladders may be installed within a compression garment worn by the dog. Upon activation, the pump 108 provides air to an optional manifold 1706 and then through the bladders 1708, 1712 thus causing the dog to feel an increase in the pressure exerted by the compression garment. This increased pressure simulates a hugging effect and may be used to sooth and comfort the dog. For example, some dogs become extremely anxious when they hear thunder or other loud noises. Other dogs suffer from separation anxiety when left alone. The hugging effect cause by the inflation of the air bladders 1708, 1712 may be used to comfort the dog and reduce its anxiety. The electronic driver module 1704 may receive sensor input such as ambient noise and motion, as well as remote wireless signals. In an example, a mobile device may be configured to activate the air bladders 1708 based on a user input or other networked information such as current weather conditions (e.g., the proximity to lightning).

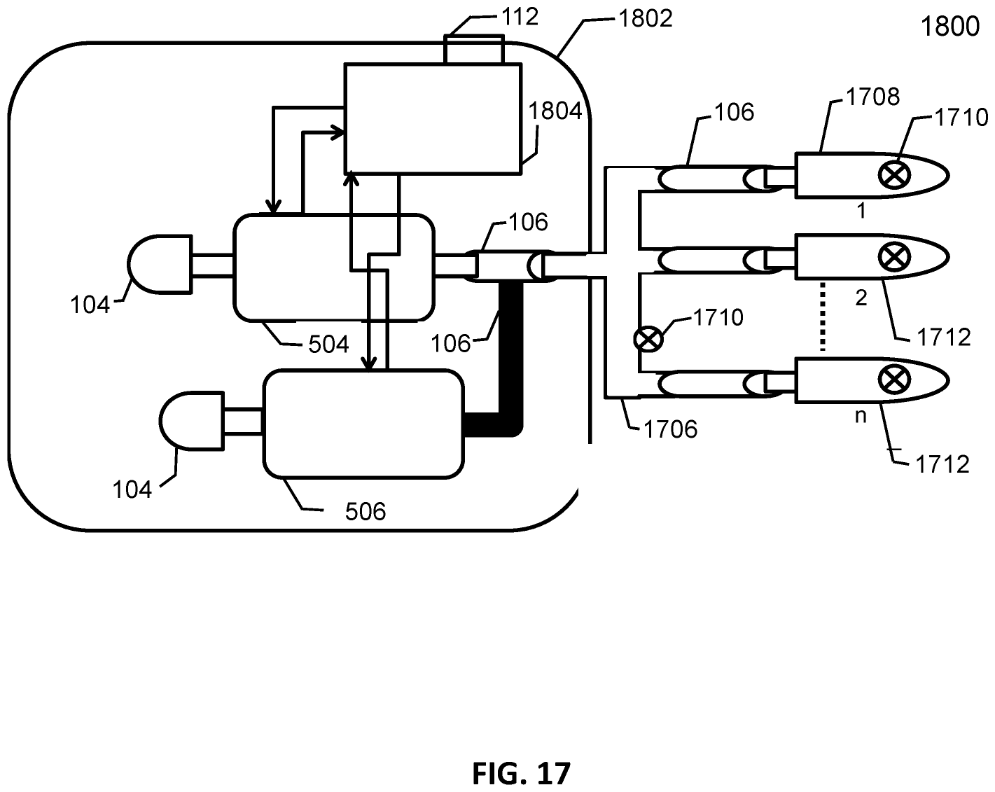

Referring to FIG. 17, with further reference to FIG. 16, an example of a multiple-pump configuration for a digitally controlled 5 system 1800 operating in positive pressure air flow mode with integrated air bladders is shown. An outer housing 1802 may contain a plurality of pumps such a first pump 504 and a second pump 506. An electronic driver module 1804 may include the components of the electronic driver module 110 and may have multiple sensors for detecting activity of or environmental conditions surrounding the wearer of the device. Based on sensor input, the pumps 504, 506 may be activated to direct positive air flow through an optional manifold 1706 and then inflate one or more air bladders indicated as 1708 in a singular air bladder configuration or as 1712 in a multiple air bladder configuration. Each air bladder for the device or an optional air manifold 1706 may contain an integrated air bleed off module 1710. The integrated air bleed off module 1710 can be designed to bleed off or release air at a very slow rate or a relatively rapid rate depending on desired application intent. Other configurations of the device are possible including additional pumps to accelerate the inflation rate for the multiple air bladder configuration 1712.

While embodiments herein generally refer to the use of pumps for the movement of fluids and gases, other mechanisms may also be used. In an example, other digitally controlled pumps such as micro diaphragm pumps may also be used. Additional pump configurations and accumulators may also be used to provide positive pressure in addition to, or as an alternative to, the pumps. In an example, one or more small compressed air cylinders may be used to provide positive pressure. In an example, the pumps are configured to nebulize the liquid chemical and directly disperse the chemical solution through a dispersal orifice.

In an example, a digitally controlled, wearable or stationary chemical dispersal device 100 containing a multi-component assembly may include a rigid exterior casing 102 also acting as a housing including interior attachment points for permanent components and replaceable components; exterior attachment points for optional replaceable modules, exterior attachment points for integration with a wearable garment, device, or stationary object, an inlet for air supply, an outlet for chemical dispersal, an adapter plug/connector 112 for a chargeable internal battery, a digitally controlled electronic pump 108 with variable flow rates capable of liquid or air mode operation, an electronic control module 110 comprising a printed circuit board, a battery-based power supply, a communication module such as an IoT chip set, a replaceable or refillable reservoir 114 containing a chemical or mixture of chemicals capable of volatilization and connected in-line to the input or output of the pump 108, a chemical vapor dispersal orifice 116 connected to the outlet of the chemical reservoir 114, and attachment features associated with the chemical vapor dispersal orifice 116 to accommodate connection to various modules on the exterior of the overall housing. An electronic driver control module 110 configured to drive the pump may be used to provide controlled air or liquid flow through or over a chemical reservoir 114. In an example, the electronic driver control module 110 may generate signals from one or more embedded sensors incorporated to monitor activity and/or the environment of the wearer of the device. Upon electronic activation of the pump, a directional air or liquid flow path may be created from the inlet towards the outlet. The pump's 108 duty cycle and flow volume may be governed according to the control signals generated by the electronic driver control module 110. The air flow or liquid flow may be controlled to deliver a consistent or variable dispersal of volatilized chemical compounds from the chemical reservoir 114 based on the electronically modulated pump 108.

In an embodiment, the activity or environmental monitoring of the device wearer is achieved through a variety of digital or analog sensing circuits within the electronic driver control module and includes one or more of the following electronic sensors: micro accelerometers, motion sensors, temperature sensors, breathing sensors, heart pulse sensors, vocalization sensors, relative humidity or water sensors, and carbon dioxide sensors, and the signals generated by the sensors within the electronic control module can modulate the activity of the pump. In an example, the electronic driver module 110 may include an IoT chipset such as the Texas Instruments SimpleLink™ MCU platform for wireless connectivity, Sitara processors and (including ARM Cortex cores). In an example, the IoT chipset may include the Qualcomm 9205 series LTE modems, including ARM Cortex A7 cores, SMB231 charger IC, PME9205 power management IC, SDR105 radio transceiver and front-end IC, and WCD9306 audio codec IC. The IoT chipset may include an integrated GNSS receiver.

The chemical dispersal device may include a replaceable chemical reservoir sub-system configured for insertion into the system's housing 102, such that an inlet and an outlet of the reservoir 114 enables fluid connection to the pump and the chemical dispersal orifice 116, and a porous sponge or wick material within the reservoir 114 that is capable of absorbing a liquid chemical solution and releasing the volatilized chemicals upon exposure to air flow. The positive air pressure from the pump 108 is configured to carry volatilized chemicals towards the chemical dispersal orifice 116 and exterior of device. A chemical dispersal orifice 116 may be connected to the output of the chemical reservoir 114 to facilitate delivery of volatilized chemicals to the exterior of the device. The dispersal device may also include an attachment feature on or within the chemical dispersal orifice 116 configured to enable the addition of specific modules for certain applications. In an example, a replaceable trap module configured to immobilize certain pests such as ticks may be attached to the chemical dispersal orifice. The replaceable trap module 218 may comprises a substrate, an immobilizing adhesive layer, and a removable protective layer covering the adhesive. A porous sheath may surround the replaceable trap module 218 acting to simultaneously protect the adhesive layer from the environment and allow conveyance of the pest to the adhesive layer.

In an example, a replaceable or refillable chemical reservoir module 314 may be configured for insertion into the system's housing, such that when negative pressure from the pump is applied, liquid is drawn from the chemical reservoir, through the pump, and into a secondary chemical reservoir 614 containing a porous sponge. A secondary chemical reservoir 614 may be configured as a source for chemical volatilization when the pump starts to pump air. An air pump 506 may be disposed between the primary liquid pump and the secondary chemical reservoir, such that the volume of liquid pumped from the primary replaceable or refillable chemical reservoir through the liquid pump to the secondary chemical reservoir 614 is metered or controlled by the electronic control module 110. The duty cycle of the air pump 506 may be controlled by the electronic control module 110. In an example, the chemical reservoir 114 may be integrated with the chemical dispersal orifice 116 to form a combination chemical reservoir and dispersal orifice module. The chemical reservoir 114 may include an accessible port and may be refillable by an injector or other means.

In an example, control of the electronic control module 110 may be enabled via Bluetooth, or other wireless communication link configured to allow a user to set variables controlling the pump operation remotely and bypass, disable, or operationally delay sensor inputs. In an example, the chemical dispersal device may be attached to a stationary object, and the electronic control associated with activity-based sensors may be temporarily bypassed, disabled, or operationally delayed.

In an example, a moisture indicator may be integrated into the exterior housing to indicate excessive water exposure or water immersion of the device. Another indicator may be integrated into the exterior housing 102 to indicate depletion of chemical within the reservoir of the device. Another indicator may be integrated into the exterior housing 102 to indicate battery charge status of the device. In an example, the pump duty cycle may be manually adjusted via a thumbwheel or other electro-mechanical device disposed on the exterior housing.

In an embodiment, a wearable or stationary digitally controlled chemical dispersal device includes a digitally controlled electronic pump 108 with variable flow rates capable of liquid or air mode operation, an electronic control module 1704 operably coupled to the digitally controlled electronic pump 108 and configured to control a flow rate based on one or more pump parameters, a replaceable or refillable reservoir 114 containing a chemical or mixture of chemicals capable of volatilization and connected in-line to the input or output of the pump, a chemical vapor dispersal orifice 116 connected to the outlet of the chemical reservoir, and a heater module connected to the chemical vapor dispersal orifice.

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C,” or “A, B, or C, or a combination thereof” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

A wireless communication system is one in which at least some communications are conveyed wirelessly, e.g., by electromagnetic and/or acoustic waves propagating through atmospheric space rather than through a wire or other physical connection. A wireless communication network may not have all communications transmitted wirelessly but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected, coupled (e.g., communicatively coupled), or communicating with each other are operably coupled. That is, they may be directly or indirectly, wired and/or wirelessly, connected to enable signal or fluid transmission between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

“About” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Further, more than one invention may be disclosed.

What is claimed is:

1. A digitally controlled dispersal system, comprising:
a housing;
a pump disposed within the housing, the pump including an input and output;
a chemical reservoir disposed within the housing and fluidly coupled to the pump;
a chemical dispersal orifice fluidly coupled to the chemical reservoir and configured to deliver volatized chemicals to an area outside of the housing;
an electronic driver module operably coupled to the pump, the electronic driver module including at least one processor configured to:
determine an application value associated with a utilization of the digitally controlled dispersal system;
set pump timing parameters based at least in part on the application value; and
activate the pump based on the pump timing parameters.

2. The digitally controlled dispersal system of claim 1 wherein the chemical reservoir is fluidly connected to the pump input and the chemical dispersal orifice is fluidly connected to the pump output.

3. The digitally controlled dispersal system of claim 1 wherein the chemical reservoir is connected to the pump output and the pump is configured to pump air into the chemical reservoir to deliver a chemical in the chemical reservoir to the chemical dispersal orifice.

4. The digitally controlled dispersal system of claim 1 wherein the chemical reservoir includes an absorbent material.

5. The digitally controlled dispersal system of claim 1 further comprising a removable trap module configured to be attached and detached proximate to the chemical dispersal orifice.

6. The digitally controlled dispersal system of claim 5 further comprising a heater module disposed proximate to the removable trap module.

7. The digitally controlled dispersal system of claim 1 further comprising a secondary chemical reservoir fluidly connected to the chemical reservoir.

8. The digitally controlled dispersal system of claim 1 wherein the electronic driver module includes an Internet of Things (IoT) chipset.

9. The digitally controlled dispersal system of claim 1 wherein the electronic driver module includes a motion sensor configured to detect a motion of the digitally controlled dispersal system.

10. The digitally controlled dispersal system of claim 9 wherein the at least one processor is operably coupled to the motion sensor and further configured to:
determine an activity value associated with the utilization of the digitally controlled dispersal system; and
set the pump timing parameters based at least in part on the activity value.

11. The digitally controlled dispersal system of claim 1 wherein the at least one processor is further configured to:
determine an environment value associated with the utilization of the digitally controlled dispersal system; and
set the pump timing parameters based at least in part on the environment value.

12. The digitally controlled dispersal system of claim 1 further comprising a wireless transceiver operably coupled to the at least one processor, and the at least one processor is further configured to obtain the pump timing parameters from a server via a wireless network.

13. The digitally controlled dispersal system of claim 1 further comprising a wireless transceiver operably coupled to the at least one processor, and the at least one processor is further configured to obtain the pump timing parameters from a mobile device via a wireless communication protocol.

14. The digitally controlled dispersal system of claim 1 further comprising a wireless transceiver operably coupled to the at least one processor, and the at least one processor is further configured to provide the pump timing parameters to a server via a wireless network.

15. A method of controlling a chemical dispersal device, comprising:
determining an application value associated with a utilization of the chemical dispersal device;
determining pump timing parameters based at least in part on the application value; and
operating a pump based on the pump timing parameters, wherein the pump is operably coupled to an electronic driver module and configured to deliver a chemical to an area external from the chemical dispersal device.

16. The method of claim 15 further comprising:
determining one or more environment values associated with the utilization of the chemical dispersal device; and
determining the pump timing parameters based at least in part on the one or more environment values.

17. The method of claim 15 further comprising:
determining an activity value associated with the utilization of the chemical dispersal device; and
determining the pump timing parameters based at least in part on the activity value.

18. The method of claim 15 wherein determining the pump timing parameters includes obtaining the pump timing parameters from a server via a wireless network.

19. The method of claim 15 wherein operating the pump based on the pump timing parameters includes providing the pump timing parameters to the electronic driver module via a wireless communication protocol.

20. A digitally controlled pump system, comprising:
a housing;
a pump disposed within the housing, the pump including an input and output;
a plurality of air bladders fluidly connected to the pump output;
at least one motion sensor;
an electronic driver module operably coupled to the pump and the at least one motion sensor, the electronic driver module including at least one processor configured to:
determine an activity value based on a signal provide by the at least one motion sensor;
set pump timing parameters based at least in part on the activity value; and
activate the pump based on the pump timing parameters.
